(19) United States
(12) Patent Application Publication
(10) Pub. No.: US 2007/0023956 A1
(43) Pub. Date: Feb. 1, 2007

(54) Polymer molding method

(75) Inventor: Fa-Shen Chen, Taichung City (TW)

Correspondence Address: TROXELL LAW OFFICE PLLC, SUITE 1404, 5205 LEESBURG PIKE, FALLS CHURCH, VA, 22041, US

(73) Assignee: KING STEEL MACHINERY CO., LTD.

(21) Appl. No.: 11/189,864

(22) Filed: Jul. 27, 2005

(51) Int. Cl. B29C 45/16

(52) U.S. Cl. 264/255

(57) ABSTRACT

A polymer molding method especially applicable to at least two materials with different physical or chemical properties. In respective procedures, the two different materials are respectively molded into blanks with certain shapes. Then the blanks are together positioned in a product mold cavity. Then a certain heat and pressure are applied to the blanks in the product mold cavity to make the blanks react in the product mold cavity and combine with each other to form a product with desired shape.

### BACKGROUND OF THE INVENTION

The present invention is related to a polymer processing technique, and more particularly to a polymer molding method.

In a conventional multicolor polymer molding method, a mold composed of upper, middle and lower mold sections is employed. Referring to FIG. 1, with ethylene-vinyl acetate copolymer (EVA) exemplified, the conventional multicolor polymer molding method includes steps of:
A. in a closed state, using an injection apparatus to inject a molten EVA material with a first color into a preliminary mold cavity between the middle and lower mold sections to form a first blank;
B. in an opened state, removing the middle mold section and leaving the first blank in the mold pit of the lower mold section;
C. mating the upper mold section with the lower mold section into a closed state, the mold pit of the lower mold section and the mold pit of the upper mold section together forming a mold cavity in which the first blank is accommodated; and
D. using an injection apparatus to inject a molten EVA material with a second color into the mold cavity to complete the injection molding operation for double-color EVA.

High-quality multicolor polymer cannot be manufactured by means of the above conventional technique. This is because after the preliminary blank with the first color is made, the preliminary blank is not cooled and still has a considerably high temperature. Therefore, when injecting the material with the second color into the mold cavity, the preliminary blank tends to deform. In addition, when the material with the second color is injected from the injection apparatus, the material is also in a high-temperature molten state. Furthermore, the injection apparatus must apply a considerable pressure onto the viscous material with the second color for injecting the material into the mold cavity. Due to the above three factors, the material with the second color will inevitably impact and deform the surface of the preliminary blank. As a result, the material with the first color will be entrained by the material with the second color to flow out of the preliminary mold cavity. Therefore, the first color and second color will infiltrate into and mix with each other. Accordingly, the color blocks of the first and second colors will be displaced from the predetermined range.

FIG. 2 shows a molding method for multicolor rubber. The mold is composed of upper, middle and lower mold sections. This method is different from the above method in that the material is respectively injected into the mold cavities between the upper and middle mold sections and between the middle and lower mold sections. After molded, the middle mold section is removed and the upper and lower mold sections are mated with each other to define a mold cavity. The blank further reacts in the mold cavity to achieve the product. By means of this technique, the problems of infiltration and displacement of the colors can be solved. However, such technique will hinder the manufacturing procedure and threaten the safety of the workers. The reason is that when molding the material into the blanks, the waste material such as the material stalk must be cleaned up when the mold is opened. At this time, the mold still has a considerably high temperature. As a result, when cleaning up the waste material, the worker tends to be burnt by the hot mold. Moreover, with the mold still having high temperature, the worker must open the mold for a long time to clean up the waste material. Under such circumstance, the blanks are not confined by the mold and tend to deform and bend due to the effect of the temperature. As a result, the quality of the product will be affected.

### SUMMARY OF THE INVENTION

It is therefore a primary object of the present invention to provide a polymer molding method by which the manufacturing efficiency of polymer can be enhanced and the quality of the polymer product can be ensured.

According to the above object, the polymer molding method of the present invention includes steps of:
a. preparing a first mold section and a second mold section, a face of the first mold section being formed with a first mold pit with a certain depth, a face of the second mold section being attachable to the face of the first mold section to close the first mold pit and form a blank mold cavity between the first and second mold sections;
b. injecting a polymer material from outer side into the blank mold cavity to obtain a first blank with a shape corresponding to the shape of the blank mold cavity;
c. separating and spacing the first and second mold sections from each other with the first blank inlaid in the first mold pit and attaching to the face of the first mold section;
d. preparing a third mold section, a face of the third mold section being formed with a third mold pit with a predetermined shape, the face of the second mold section being attachable to the face of the first mold section, whereby the first mold pit and the third mold pit are mated with each other to form a product mold cavity between the first and third mold sections, a second blank with a predetermined shape being filled into the third mold pit and positioned in a predetermined position;
e. mating the third mold section with the first mold section and making the first and second blanks abut against and attach to each other; and
f. making the first and second blanks chemically react in the product mold cavity to obtain a product.

The present invention can be best understood through the following description and accompanying drawings wherein:

### BRIEF DESCRIPTION OF THE DRAWINGS

FIG. 1 is a flow chart of a conventional polymer molding method;

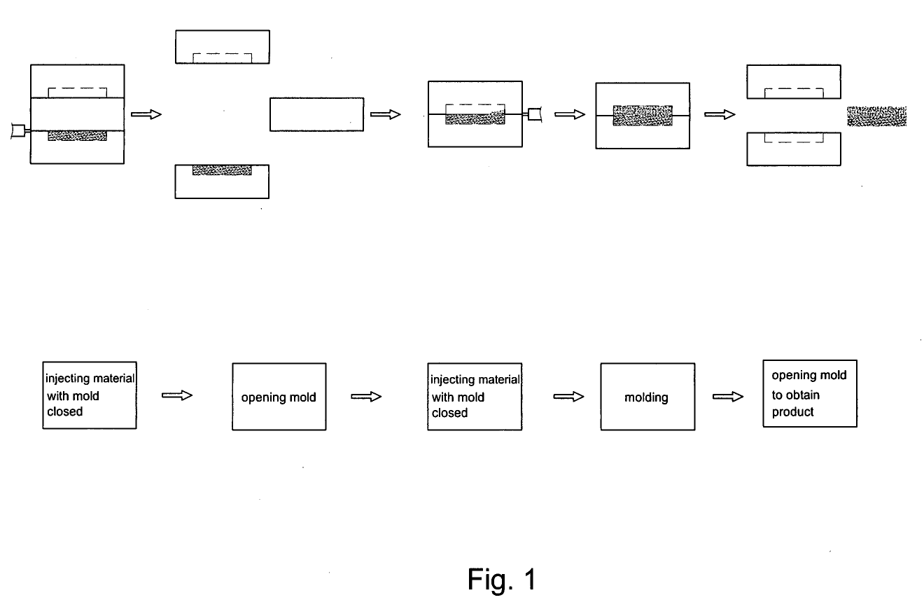

FIG. 2 is a flow chart of another conventional polymer molding method; and

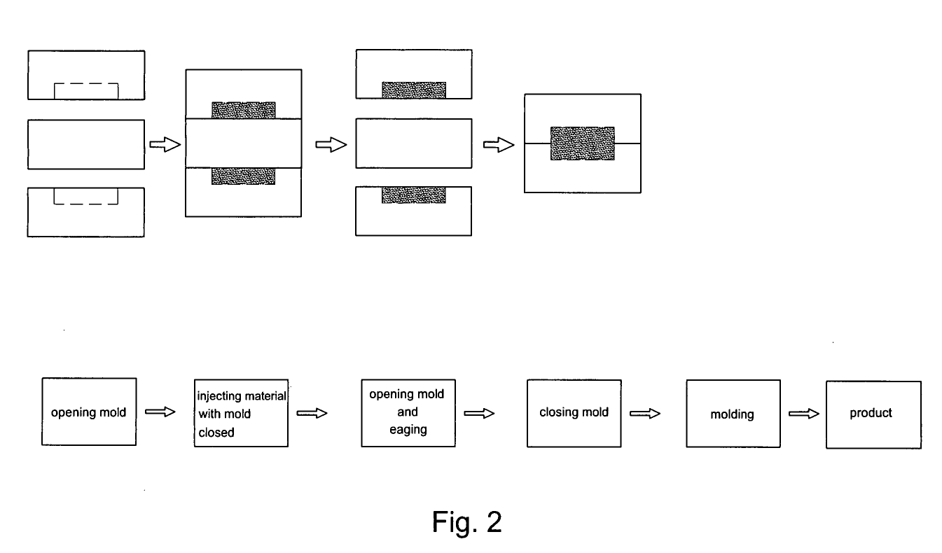

FIG. 3 is a flow chart of the polymer molding method of the present invention.

### DETAILED DESCRIPTION OF THE PREFERRED EMBODIMENTS

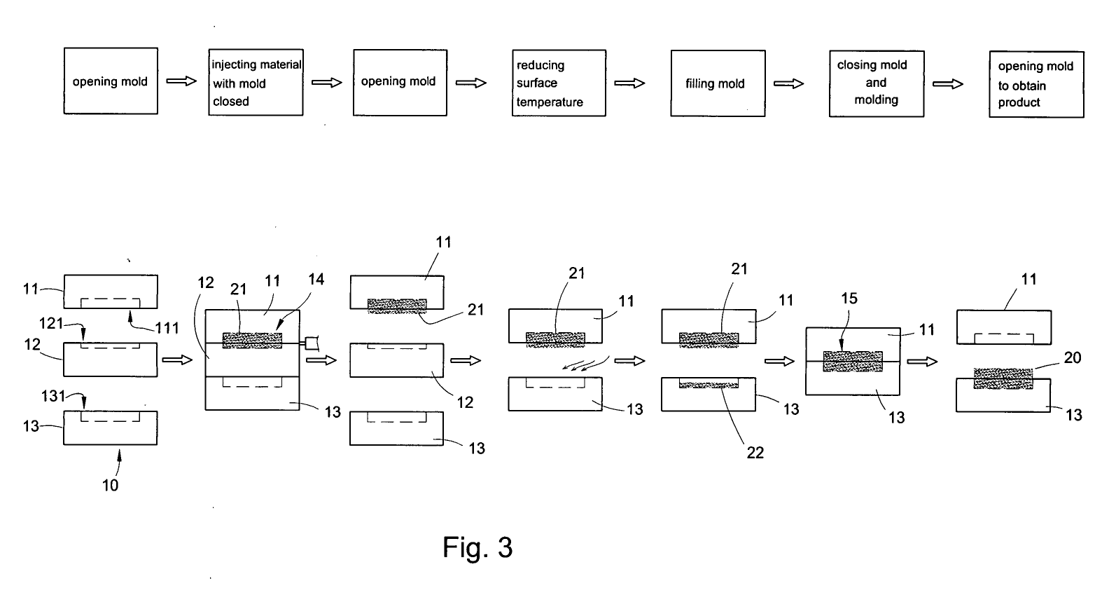

Please refer to FIG. 3. The polymer molding method of the present invention includes steps of:
a. preparing a mold 10 composed of a first mold section 11, a second mold section 12 and a third mold section 13, a lower face of the first mold section 11 being formed with a first mold pit 111 with a certain depth, a top face of the second mold section 12 being formed with a second mold pit 121 corresponding to the first mold pit 111, an upper face of the third mold section 13 being formed with a third mold pit 131 with a certain depth, in a closed state, the first mold section 11 being overlaid on the second mold section 12 and the second mold section 12 being overlaid on the third mold section 13, the second mold pit 121 and the first mold pit 111 being mated with each other to form a blank mold cavity 14 between the first and second mold sections 11, 12, the mold 10 being kept at a certain temperature over a reaction temperature of the material to be molded, whereby the time for ascending/descending the temperature of the mold 10 is saved;
b. in the closed state of the mold 10, using an injection apparatus to inject a certain amount of molten polymer material through a flow way into the blank mold cavity 14, the polymer material being previously molten at a temperature below the reaction temperature, after injected into the blank mold cavity 14, the polymer material being molded into a first blank 21;
c. opening the mold 10 and separating the mold sections 11, 12, 13 from each other by certain distances, the first blank 21 being inlaid in the first mold pit 111 and attaching to the lower face of the first mold section 11, the second mold section 12 being horizontally transversely moved away from a range within which the first and third mold sections 11, 13 are vertically movable;
d. reducing surface temperature of the third mold pit 131 of the third mold section 13 with low-temperature fluid and filling a second blank 22 with a predetermined shape into the third mold pit 131 and positioned in a true position;
e. mating the third mold section 13 with the first mold section 11 and making the third mold pit 131 and the first mold pit 111 together form a product mold cavity 15 in which the second blank 22 and the first blank 21 abut against and attach to each other; and
f. providing a certain pressure to keep the mold 10 closed and making the heat of the mold 10 gradually transmitted to the interior of the product mold cavity 15, whereby the temperature of the blanks 21, 22 ascends to a value over the reaction temperature of the blanks 21, 22 for chemical reaction thereof and obtaining a product 20 with desired shape.

In the above method, the colors, densities or other physical properties of the blanks 21, 22 are not limited. The method is applicable to the blanks 21, 22 with different colors or densities. Step d is an omissible step, depending on whether the shape of the second blank is subject to deformation of temperature. In the case that the second blank has a considerable volume and thickness and is not easy to deform in short time due to temperature, the step of reducing surface temperature can be omitted. The low-temperature fluid can be selected according to the actual performances of the material.

In comparison with the conventional technique, the present invention at least has the following advantages:
1. The materials will not be mixed. In the present invention, the blanks 21, 22 combine in the product mold cavity 15 not under condition of high pressure as in the prior art. Accordingly, the blanks are prevented from being disturbed and the blanks will not flow relative to each other so that the contact surfaces of the blanks will not mix with each other.
2. In the case that the blanks 21, 22 have different colors, since the materials will not mix with each other, the problem of infiltration or displacement of colors can be avoided.
3. In this invention, prior to filling the second blank 22 into the third mold pit 131, the second blank 22 has already been molded. In other words, the second blank 22 only needs to be filled into the third mold pit 131 and positioned in a true position. Accordingly, it is unnecessary to clean up the waste material from the mold sections as in the conventional technique. Therefore, the manufacturing time can be shortened.
4. In comparison with the waste cleaning procedure of the conventional method, the filling procedure of the second blank 22 can be easily and quickly completed. Therefore, the workers are unnecessary to contact with the high-temperature mold for a long time so that the possible hurt of the works caused by the hot mold can be avoided.
5. In the polymer molding method of the present invention, the mold is kept at a temperature over the reaction temperature of the blank. Therefore, the time for ascending/descending the temperature of the mold 10 is saved. In addition, the high temperature of the mold 10 serves as an environmental temperature and the heat of the mold 10 is transmitted to the blanks in short time, making the temperature of the blanks ascends up to the reaction temperature of the blanks for chemical reaction thereof. Therefore, the manufacturing time is greatly shortened and the manufacturing efficiency is enhanced.

The above embodiments are only used to illustrate the present invention, not intended to limit the scope thereof. Many modifications of the above embodiments can be made without departing from the spirit of the present invention.

What is claimed is:

1. A polymer molding method comprising steps of:
a. preparing a first mold section and a second mold section, a face of the first mold section being formed with a first mold pit with a certain depth, a face of the second mold section being attachable to the face of the first mold section to close the first mold pit and form a blank mold cavity between the first and second mold sections;
b. injecting a polymer material from outer side into the blank mold cavity to obtain a first blank with a shape corresponding to the shape of the blank mold cavity;
c. separating and spacing the first and second mold sections from each other with the first blank inlaid in the first mold pit and attaching to the face of the first mold section;
d. preparing a third mold section, a face of the third mold section being formed with a third mold pit with a predetermined shape, the face of the second mold section being attachable to the face of the first mold section, whereby the first mold pit and the third mold pit are mated with each other to form a product mold cavity between the first and third mold sections, a second blank with a predetermined shape being filled into the third mold pit and positioned in a predetermined position;
e. mating the third mold section with the first mold section and making the first and second blanks abut against and attach to each other; and
f. making the first and second blanks chemically react in the product mold cavity to obtain a product.

2. The polymer molding method as claimed in claim 1, wherein the first and second blanks have different colors.

3. The polymer molding method as claimed in claim 1, wherein the first and second blanks have different densities.

4. The polymer molding method as claimed in claim 1, wherein the first mold section is overlaid on the second mold section and the third mold section and the mold sections are vertically movable to open and close the mold.

5. The polymer molding method as claimed in claim 4, wherein in step f, the second mold section is moved away from a range within which the first and third mold sections are vertically mated with each other, whereby the first and third mold sections can be vertically moved to mate with each other so as to close the mold.

6. The polymer molding method as claimed in claim 5, wherein the step d is performed with the mold sections separated from each other.

7. The polymer molding method as claimed in claim 6, wherein in step d, surface temperature of the third mold pit of the third mold section is first reduced with a fluid and then the second blank is filled into the third mold pit.

8. The polymer molding method as claimed in claim 7, wherein the fluid is a gas.

9. The polymer molding method as claimed in claim 1, wherein the mold sections at least have a temperature equal to reaction temperature of the blank to be filled in the mold cavity.
